(19) United States
(12) Patent Application Publication
(10) Pub. No.: US 2004/0103290 A1
(43) Pub. Date: May 27, 2004

(54) System and method for controlling the right to use an item

(76) Inventor: David P. Mankins, Cambridge, MA (US)

Correspondence Address: VERIZON CORPORATE SERVICES GROUP INC., C/O CHRISTIAN R. ANDERSEN, 600 HIDDEN RIDGE DRIVE, MAILCODE HQEO3H14, IRVING, TX, 75038, US

(21) Appl. No.: 10/302,218

(22) Filed: Nov. 22, 2002

(51) Int. Cl. H04L 9/32

(52) U.S. Cl. 713/193

(57) ABSTRACT

Systems and methods are provided for controlling the right to use an item. A user seeking the use of the item may communicate to a server a code identifying a security object and any other information requested by the server. The server may use the code to retrieve a key associated with the security object. The server may execute a cryptographic algorithm on at least the key and a time-dependent input to generate a one-time password, which the server may report to the user. The one-time password may be used to successfully gain access to the security object item only once within a predetermined period of time. The security object, which is disconnected from the server, may receive from the user the one-time password and execute a cryptographic algorithm on a locally-retrieved key and a time-dependent input to generate another one-time password. If the one-time passwords match, the user may be granted access to the item.

### FIELD OF THE INVENTION

The present invention relates to systems and methods for controlling the right to use an item.

### BACKGROUND OF THE INVENTION

A wide variety of goods and services are sold using vending machines. In most cases, a buyer inserts cash, a credit card, or the like into a vending machine in exchange for the desired purchase. To give buyers greater flexibility, some vending machines have been modified to permit not only such traditional cash or credit card sales, but also sales initiated by a mobile telephone call from the buyer to a central service facility, which authorizes the sale after verifying sufficient credit in the buyer's established account.

Systems supporting mobile-telephone-initiated sales from vending machines typically include a communication network, which links a number of vending machines to a central service facility. Employing the communication network, the central service facility receives and maintains user account information. The central service facility also receives and processes over the communication network user calls to make a purchase from a vending machine.

Vending machines that can process mobile-telephone-initiated sales presently require either a wired or wireless connection to the communication network. Drawbacks associated with a vending machine using a wired network connection include: (1) machine placement restrictions (i.e., the machine must be located where a wired network connection can be made); (2) wire installation cost; (3) modem cost; (4) monthly telephone charge for the machine; (5) reducing the number of available telephone numbers; and (6) reducing the usable bandwidth of the communication spectrum. Even a vending machine using a wireless network connection has the limitations (3) to (6) of above.

### SUMMARY OF THE INVENTION

Systems and methods are provided for controlling the right to use an item. A system consistent with the present invention may include a server and a security object. The server may operate on a plurality of inputs to generate a result. The security object, which is disconnected from the server, is configured to receive the result and determine whether to grant the right to use the item based on the result.

A method consistent with the present invention may include a server accessing a code and generating a result based on the code. The code may identify a security object that is disconnected from the server and that controls the right to use the item based on the result.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a block diagram of a system employing security objects to control the right to use items, in accordance with systems and methods consistent with the present invention.

FIG. 2 is a block diagram of the use control server of FIG. 1, in accordance with systems and methods consistent with the present invention.

FIG. 3 is a block diagram of the use control device of FIG. 1, in accordance with systems and methods consistent with the present invention.

FIG. 4 is a flowchart representing a method for controlling the right to use an item, in accordance with systems and methods consistent with the present invention.

### DESCRIPTION OF THE EMBODIMENTS

Reference will now be made in detail to the present exemplary embodiments of the invention, examples of which are illustrated in the accompanying drawings. Wherever possible, the same reference numbers will be used throughout the drawings to refer to the same or like parts.

Systems and methods are provided for controlling the right to use an item. For example, a user seeking the use of the item may communicate to a server a code identifying a security object and any other information requested by the server. The server may use the code to retrieve a key associated with the security object. The server may execute a cryptographic algorithm on at least the key and a time-dependent input to generate a one-time password, which the server may report to the user. The one-time password may be used to successfully gain access to the security object item only once within a predetermined period of time. The security object, which is disconnected from the server, may receive from the user the one-time password and execute a cryptographic algorithm on a locally-retrieved key and a time-dependent input to generate another one-time password. If the one-time passwords match, the user may be granted access to the item.

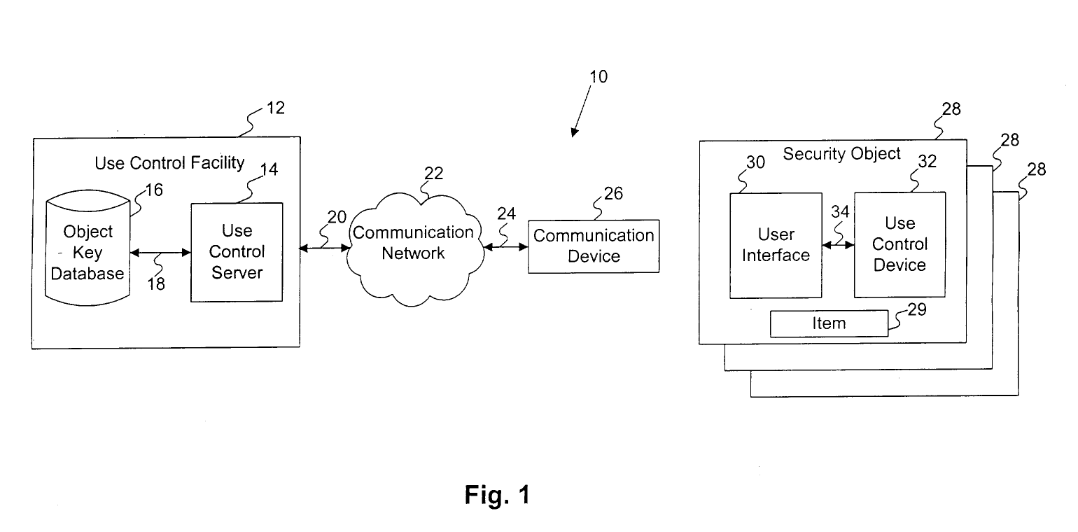

FIG. 1 shows a block diagram of a system 10 employing one or more security objects 28 to control the right to use one or more items 29, in accordance with systems and methods consistent with the present invention. The system 10 may include a use control facility 12, a communication network 22, a communication device 26, and one or more security objects 28 each including one or more items 29. Requests for the right to use an item 29 may be submitted from a user's communication device 26 to the use control facility 12 over the communication network 22. Such communication-device-initiated (hereinafter “CDI”) requests may typically be “cashless” requests for the right to use an item 29 (i.e., the user does not provide cash, a credit card, or other access control devices to a security object 28 for the right to use an item 29). However, a security object 28 may also receive a request for an item 29 from a user who submits cash, a credit card, or any other access control device to the security object 28.

The use control facility 12 includes an object key database 16 linked by a connection 18 to a use control server 14. Each security object 28 in the system 10 may be uniquely represented in the object key database 16. For instance, the object key database 16 may include a code and a key, both uniquely associated with a particular security object 28. The code may identify the particular security object 28, while the key associated with that code may be employed by the use control server 14 to facilitate granting the right to use the item 29 related to that security object 28.

The communication network 22 may be linked by connection 20 to the use control facility 12. The connection 20 may be wired, wireless, or a combination of both. The communication network 22 may be any network supporting voice and/or data communication, such as a mobile telephone network.

The communication device 26 may be linked by connection 24 to the communication network 22. The connection 24 may be wired, wireless, or a combination of both. The communication device 26 may be any communication device supporting voice and/or data communication, such as a mobile telephone.

The security object 28 may include a vending machine supporting CDI requests for the right to use an item 29, such as a good and/or a service being offered for sale by the vending machine. The vending machine may also support traditional cash or credit card sales.

While in this embodiment the security object 28 is described as a vending machine, the security object 28 may encompass any other object that in some manner controls the right to use an item related to the object. For example, the system 10 may be employed to control the right to use a parking space (i.e., an item 29) related to a security object 28, such as a parking meter. Likewise, the system 10 may be utilized to control the right to use anything with restricted access, such as a locked space (i.e., the item 29) by way of a related security object 28, such as a locked access (e.g., a locked door, window, etc.).

Moreover, physical access to use one or more items 29 may or may not be restrained by the related security object 28. For example, a vending machine typically may provide a physical boundary against unauthorized access to use items offered by the machine. Likewise, a locked door may normally provide a physical boundary against unauthorized access to use the related locked space. Conversely, a parking meter typically may not provide a physical barrier against unauthorized access to use the related parking space. Instead, restriction against unauthorized parking may take the form of a parking violation, which a user can avoid by obtaining authorization to use the parking space. Thus, controlling the right to use an item 29 may include controlling access through a physical boundary against unauthorized access to use that item 29 and/or controlling the grant of authorization to use the item 29.

Regardless of the type of the security object 28 (e.g., a vending machine, a parking meter, a locked door to a facility or to a room, etc.), the security object 28 need not be connected by wire or wireless link to the use control server 14. As a result, the security object 28 may be remotely located in places without access to network connection back to the server 14. Additionally, because the security object 28 does not need to be connected to the server 14, there may be no wire installation or modem cost and no monthly telephone charge for the security object 28.

The security object 28 may include a user interface 30 linked by connection 34 to a use control device 32. The user interface 30 may comprise any system for exchanging information between the security object 28 and the user and/or between the security object 28 and the user's communication device 26. For example, the user interface 30 may include one or more of the following: a keypad, an electronic or a non-electronic display, a printer, a bar code reader, and a transceiver for any desired frequency in the electromagnetic radiation spectrum, such as infrared or humanly-perceptible audible sound.

Through the user interface 30, a user may exchange with the security object 28 information used by the security object 28 to determine whether to grant the user's CDI request to use an item 29. For example, the user interface 30 may provide the user with contact information, such as a telephone number for contacting the use control server 14. The user interface 30 may also provide the user with the security object's code, which identifies the security object 28 being accessed by the user. The user may then contact the use control server 14 with the communication device 26 and present the code to the use control server 14.

The use control server 14 may then generate a result based on the information the user presents to the use control server 14 and send the result over the communication network 22 to the user's communication device 26. The user may then present the result received from the use control server 14 to the security object 28. Finally, the use control device 32 in security object 28 may employ the result to control the use of the item 29.

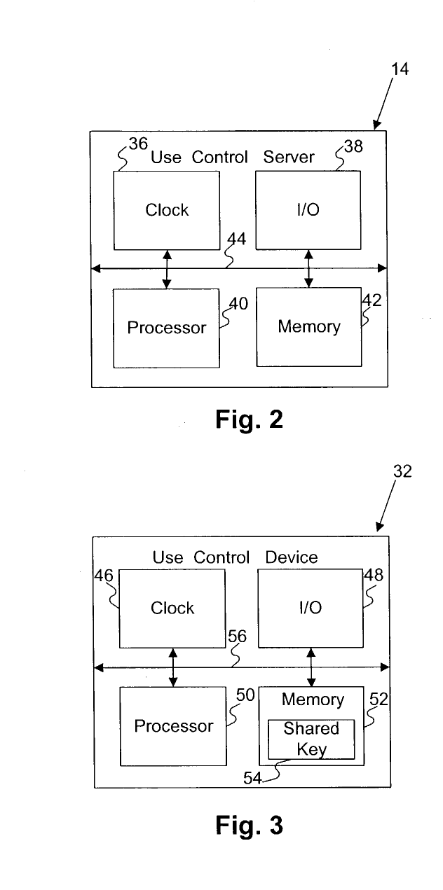

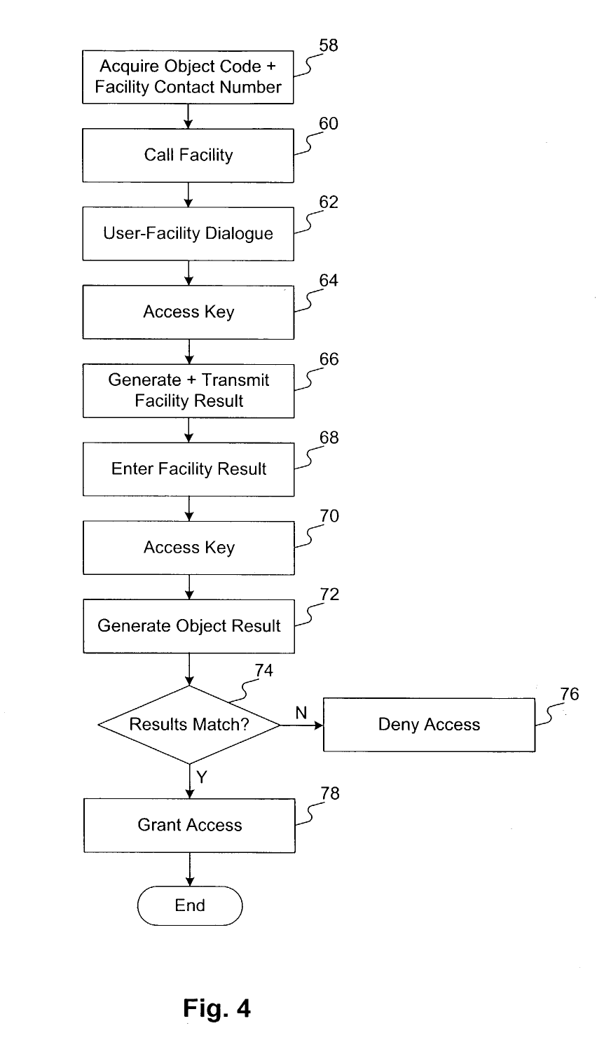

FIG. 2 is a block diagram of the use control server 14 of FIG. 1, in accordance with systems and methods consistent with the present invention. The use control server 14 may include a processor 40, a memory 42, an input/output (“I/O”) means 38, a clock 36, and a bus 44. The memory 42 may include an executable program that when executed by processor 40 implements a predetermined policy for responding to a user's CDI request for the use of an item 29. The processor 40 may also retrieve data, such as the code and key for a security object 28, from memory 42 or the object key database 16. The use control server 14 may send and receive information via I/O means 38. As later discussed with respect to FIG. 4, the clock 36 may be employed by the use control server 14 to generate a result, which may then be sent over the communication network 22 to the user's communication device 26.

FIG. 3 is a block diagram of the use control device 32 of FIG. 1, in accordance with systems and methods consistent with the present invention. The use control device 32 may include a processor 50, a memory 52, an I/O means 48, a clock 46, and a bus 56. The memory 52 may include an executable program for controlling the use control device 32, the user interface 30, and/or other security object systems. Also residing in memory 52 may be a shared key 54 uniquely associated with the security object 28. The shared key 54 may also reside in the object key database 16, which may reflect the relationship of the code and shared key 54 associated with each of the security objects 28 in the system 10. The processor 50 may execute the program to control the operation of at least the use control device 32. The processor 50 may also retrieve the shared key 54, data from the user interface 30, and/or other data made available from the security object 28 (e.g., one or more status indicators for a vending machine, parking meter, etc.). The use control device 32 may send and receive information via I/O means 48. As later discussed with respect to FIG. 4, the clock 46 may be employed by the use control device 32 to generate a result for determining whether to grant a user's request to use the item 29.

FIG. 4 is a flowchart of a method for processing CDI requests for the right to use an item 29 in one or more security objects 28, in accordance with systems and methods consistent with the present invention. Before using the system 10, each user may register with the use control server 14 by providing information, such as the user's name and contact information; an account to pay for the use of the system 10 and/or for purchases from a security object 28; an identifier for the user's communication device 26, such as a mobile telephone number; and any other desired information.

A registered user may use a security object 28, such as a vending machine that is disconnected from the use control server 14 (i.e., neither wired, nor wirelessly connected to the use control server 14). The vending machine may be outfitted to support purchases made with cash, a credit card, or the like.

When the user makes a CDI request for use of an item 29 at step 58, the user receives from the vending machine a code that may be used to identify the vending machine and the contact number for the use control server 14. For example, the vending machine's user interface 30 may show the vending machine's code, the use control server's contact number, as well as appropriate instructions.

At step 60, the user may contact the use control server 14 using the contact number provided at step 58. For example, the user could employ his mobile telephone (i.e., communication device 26), which may be registered with the use control server 14, to place a call over the communication network 22 to use control server 14. Those skilled in the art understand that the communication device 26 need not be a mobile telephone, as it could be any device that enables communication with the use control server 14 over the communication network 22.

Moreover, those skilled in the art also understand that the user need not contact the use control server 14 with a communication device 26 that is registered with the server 14. Contacting the use control server 14 with a registered communication device 26 may identify the caller, depending on how the system's predetermined use control policy is set up. Alternatively, the system's predetermined use control policy could permit the user to contact the use control server 14 with an unregistered communication device 26 and provide information, such as a personal identification number, to the server 14.

At step 62, the user may enter a dialogue with the use control server 14 consistent with the system's predetermined use control policy. This policy may be established as desired by a controlling entity, such as a company controlling access to vending machines in the system 10. Those skilled in the art appreciate that there are many different ways of setting up rules defining a policy to control the user's interaction with a security object 28 for the right to use an item 29.

During the dialogue, the user may provide the vending machine's code to the use control server 14. Depending on the system's predetermined use control policy, additional information may be sought from the user, such as the product number or price of a desired item in the vending machine. The user may provide the requested information from his communication device 26.

At step 64, the use control server 14 may receive the user-provided code for the vending machine and retrieve the associated key from the object key database 16.

At step 66, the use control server 14 may use the retrieved key associated with the user-provided code to generate a facility result. For example, the use control server 14 may execute a cryptographic algorithm that processes a number of inputs to output the facility result.

In the present exemplary embodiment, the facility result may include a one-time password, such as a password that may be utilized to successfully gain access to the vending machine items only once within a predetermined period of time. The inputs to the cryptographic algorithm may include a time-dependent input and the retrieved key, which may include a constant. The time-dependent input, which may be ascertainable by the use control server 14, may include the time of day, as provided by the clock 36, although those skilled in the art understand that other time-dependent inputs may be substituted. For example, a counter maintaining the number of transactions completed by a particular vending machine could be substituted instead. Additionally, depending on the system's predetermined use control policy, the cryptographic algorithm may have other inputs, such as the price of an item 29 desired by the user.

After generating the one-time password, the use control server 14 may transmit the facility result to the user's communication device 26 over the communication network 22.

At step 68, the user may enter the facility result into the vending machine via the user interface 30.

At step 70, the user interface 30 may report the facility result to the use control device 32, which may retrieve the shared key 54. The use control device 32 may execute a cryptographic algorithm that processes a number of inputs to output an object result. The inputs to the cryptographic algorithm may include the shared key 54 and a time-dependent input, such as the time of day provided by the clock 46, although those skilled in the art understand that other time-dependent inputs may be substituted. The object result may include a one-time password, such as a password that may be utilized to successfully gain access to the vending machine items only once within a predetermined period of time.

In the present exemplary embodiment, the cryptographic algorithm executed by the use control device 32 may be the same as the cryptographic algorithm employed by the use control server 14 in step 66. Moreover, the cryptographic algorithm executed by the use control device 32 may use the same number and type of inputs as those employed by the cryptographic algorithm executed by the use control server 14 to generate the facility result in step 66. Thus, when the use control server's cryptographic algorithm has as inputs the key retrieved from the object key database 16 and a time-dependent input, the use control device's cryptographic algorithm also has as inputs the shared key 54 and a time-dependent input. If the use control server's cryptographic algorithm has other inputs, the use control device's cryptographic algorithm may have the same number and type of other inputs.

At step 74, the use control device 32 may compare its generated object result with the facility result reported by the user at step 68. If the results do not match, the user may be denied access to use the item 29 at step 76 and an appropriate message may be displayed on the user interface 30. If the results match, then the user may be granted access to the item 29 at step 78 and an appropriate message may be displayed on the user interface 30.

A match between the facility result and the object result may generally occur because the cryptographic algorithms as well as their inputs are the same in steps 66 and 72. Yet, those skilled in the art understand that when the time of day is the time-dependent input to the cryptographic algorithm in step 66, this time may differ from the time of day employed by the cryptographic algorithm at step 72. However, one can predict, or empirically obtain an average amount of time that it takes from computing the facility result at step 66 to generating the object result in step 72 and factor such time into the predetermined period of time during which a one-time password is effective. As a result, a match may still occur despite any time delay between steps 66 and 72, as long as the time delay does not exceed the predetermined period of time during which the one-time password is effective.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for controlling a right to use an item, said system comprising:
a server operating on a plurality of inputs to generate a result; and
a security object disconnected from the server and configured to receive the result and determine whether to grant the right to use the item based on the result.

2. The system of claim 1, wherein the server executes a cryptographic algorithm to generate the result.

3. The system of claim 1, wherein the plurality of inputs include a key and a time-dependent input.

4. The system of claim 1, wherein the result includes a one-time password.

5. The system of claim 1, further including a database having a key and a code used to identify the security object.

6. The system of claim 1, further including a communication network connected to the server.

7. The system of claim 6, further including a communication device connected through the communication network to the server.

8. The system of claim 1, wherein the security object includes one of a vending machine, a parking meter, and a locked access.

9. A system for controlling a right to use an item, said system comprising:
a server operating on a plurality of inputs to generate a result for use by a security object that is disconnected from the server, wherein the security object is configured to receive the result and determine whether to grant the right to use the item based on the result; and
a database including at least one of the plurality of inputs.

10. The system of claim 9, wherein the server executes a cryptographic algorithm to generate the result.

11. The system of claim 9, wherein the plurality of inputs include a key and a time-dependent input.

12. The system of claim 9, wherein the result includes a one-time password.

13. The system of claim 11, wherein the key includes the at least one of the plurality of inputs.

14. The system of claim 9, wherein the database includes a code used to identify the security object.

15. The system of claim 9, further including a communication network connected to the server.

16. The system of claim 15, further including a communication device connected through the communication network to the server.

17. The system of claim 9, wherein the security object includes one of a vending machine, a parking meter, and a locked access.

18. A security object, disconnected from a server, for controlling a right to use an item, said security object comprising:
a user interface configured to receive a first result generated by the server; and
a use control device operating on a plurality of inputs to generate a second result and comparing the first and second results to determine whether to grant the right to use the item.

19. The security object of claim 18, wherein the use control device executes a first cryptographic algorithm to generate the second result.

20. The security object of claim 18, wherein the plurality of inputs includes a key and a time-dependent input.

21. The security object of claim 18, wherein the first and second results each includes a one-time password.

22. The security object of claim 19, wherein the first cryptographic algorithm is identical to a second cryptographic algorithm executed by the server to generate the first result, and wherein the first cryptographic algorithm operates on a same number and type of inputs to generate the second result as the second cryptographic algorithm.

23. The security object of claim 18, wherein the security object may be identified with a code.

24. The security object of claim 18, wherein the security object includes one of a vending machine, a parking meter, and a locked access.

25. A method for controlling a right to use an item, comprising:
a server accessing a code used to identify a security object that controls the right to use the item and that is disconnected from the server; and
the server generating a result based on the code such that the right to use the item is determined by the security object based on the result.

26. The method of claim 25, further comprising receiving the code from a communication device connected to the server through a communication network.

27. The method of claim 25, further comprising retrieving a key related to the code.

28. The method of claim 27, wherein generating the result further includes executing a cryptographic algorithm that operates on a plurality of inputs that include the key and a time-dependent input.

29. The method of claim 26, further comprising transmitting the result through the communication network to the communication device.

30. The method of claim 25, wherein the result includes a one-time password.

31. The method of claim 25, wherein the security object includes one of a vending machine, a parking meter, and a locked access.

32. A method for controlling a right to use an item, comprising:
providing a code used to identify a security object that controls the right to use the item; and
receiving a first result based on the code and generated by a server that is disconnected from the security object.

33. The method of claim 32, further comprising retrieving a key related to the security object.

34. The method of claim 33, further comprising executing a cryptographic algorithm that operates on a plurality of inputs including the key and a time-dependent input to generate a second result.

35. The method of claim 34, further comprising granting the right to use the item if the first and second results match each other.

36. The method of claim 34, wherein the first and second results each includes a one-time password.

37. The method of claim 32, wherein the security object includes one of a vending machine, a parking meter, and a locked access.
